(19) United States
(12) Patent Application Publication
(10) Pub. No.: US 2024/0223108 A1
(43) Pub. Date: Jul. 4, 2024

(54) FLEXIBLE ACTUATOR, MANUFACTURING METHOD THEREOF, AND ELECTRONIC DEVICE

(71) Applicant: BOE TECHNOLOGY GROUP CO., LTD., Beijing (CN)

(72) Inventors: Yurong HE, Beijing (CN); Kui LIANG, Beijing (CN); Tuo SUN, Beijing (CN)

(21) Appl. No.: 17/920,112

(22) PCT Filed: Nov. 29, 2021
(86) PCT No.: PCT/CN2021/133954

§ 371 Date: Jun. 1, 2023

(51) Int. Cl. H02N 2/00

(52) U.S. Cl. CPC H02N 2/005; H02N 2/0075

(57) ABSTRACT

The present disclosure provides a flexible actuator, a manufacturing method thereof, and an electronic device, belongs to the technical field of flexible actuators, and can solve the problems that existing flexible actuators are large in size and complex in control program. The flexible actuator provided by the present disclosure includes: a plurality of flexible actuator units arranged in an array; each of the flexible actuator units includes: a driving circuit layer, and a flexible deformation layer located on a side of the driving circuit layer; the driving circuit layer is configured to provide a control signal for the flexible deformation layer; and the flexible deformation layer is configured to deform under the control of the control signal.

### TECHNICAL FIELD

The present disclosure belongs to the technical field of flexible actuators, and particularly relates to a flexible actuator, a manufacturing method thereof and an electronic device.

### BACKGROUND

With the continuous development of precise instruments, flexible actuators are widely applied in the fields of industry, agriculture, consumer electronics, military and medicine.

The existing flexible actuators generally adopt a magnetic field control principle or a pneumatic control principle to realize drive control. Due to limitations of magnetic field drivers and pneumatic drivers, the flexible actuators are large in overall volume and complex in control program, thus failing to meet the requirements of users for miniaturization and programmable control of the flexible actuators.

### SUMMARY

For solving at least one of the technical problems in the prior art, the present disclosure provides a flexible actuator, a manufacturing method thereof, and an electronic device.

In a first aspect, an embodiment of the present disclosure provides a flexible actuator, including: a plurality of flexible actuator units arranged in an array; and each of the flexible actuator units includes: a driving circuit layer, and a flexible deformation layer located on a side of the driving circuit layer. The driving circuit layer is configured to provide a control signal for the flexible deformation layer; and the flexible deformation layer is configured to deform under the control of the control signal to deform.

Optionally, the flexible deformation layer includes: a first flexible film and a second flexible film opposite to each other; and a closed cavity is formed between the first flexible film and the second flexible film; and the driving circuit layer includes: a first driving electrode and a second driving electrode; and both the first driving electrode and the second driving electrode are located on a side of the second flexible film away from the first flexible film.

Optionally, a first preset gap is between the first driving electrode and the second driving electrode, and both the first driving electrode and the second driving electrode are bent away from the first flexible film.

Optionally, a bending radian of the first driving electrode is the same as a bending radian of the second driving electrode.

Optionally, the flexible deformation layer further includes: a filler material in the closed cavity.

Optionally, a material of the filler includes: one or more of water, silicone oil and helium.

Optionally, the flexible actuator further includes: a plurality of first control signal lines and a plurality of second control signal lines arranged in an intersecting manner; first driving electrodes and second driving electrodes in a same row of flexible actuator units are connected to a same first control signal line; and first driving electrodes in a same column of flexible actuator units are connected to a same second control signal line, and second driving electrodes in a same column of flexible actuator units are connected to a same second control signal line.

Optionally, the flexible deformation layer includes: a third flexible film; and a material of the third flexible film includes: a dielectric elastomer material; and the driving circuit layer includes: a third driving electrode and a fourth driving electrode both located on a side of the third flexible film.

Optionally, a second preset gap is between the third driving electrode and the fourth driving electrode, and both the third driving electrode and the fourth driving electrode are bent toward the third flexible film.

Optionally, a bending radian of the third driving electrode is the same as a bending radian of the fourth driving electrode.

Optionally, the flexible actuator further includes: a plurality of third control signal lines and a plurality of fourth control signal lines arranged in an intersecting manner; third driving electrodes and fourth driving electrodes in a same row of flexible actuator units are connected to a same third control signal line; and third driving electrodes in a same column of flexible actuator units are connected to a same third control signal line, and fourth driving electrodes in a same column of flexible actuator units are connected to a same fourth control signal line.

Optionally, the flexible deformation layer includes: a fourth flexible film; and a material of the fourth flexible film includes: a thermal expansion material; and the driving circuit layer includes: a fifth driving electrode on a side of the fourth flexible film.

Optionally, resistance of the fifth driving electrode is greater than a preset value.

Optionally, the fifth driving electrode is bent toward the fourth flexible film.

Optionally, the flexible actuator further includes: a plurality of fifth control signal lines and a plurality of sixth control signal lines arranged in an intersecting manner; fifth driving electrodes in a same row of flexible actuator units are connected to a same fifth control signal line; and fifth driving electrodes in a same column of flexible actuator units are connected to a same sixth control signal line.

In a second aspect, an embodiment of the present disclosure provides a manufacturing method of a flexible actuator, including: forming a flexible deformation layer; and forming a driving circuit layer on a side of the flexible deformation layer, so as to form a plurality of flexible actuator units arranged in an array.

Optionally, forming the flexible deformation layer includes: forming a first flexible film; and attaching a second flexible film to the first flexible film to form a plurality of closed cavities.

Optionally, after attaching the second flexible film to the first flexible film to form the plurality of closed cavities, the method further includes: injecting a filler material into the closed cavities and sealing the closed cavities.

Optionally, forming the driving circuit layer on the side of the flexible deformation layer includes: forming a first driving electrode and a second driving electrode on a side of the second flexible film away from the first flexible film.

Optionally, forming the flexible deformation layer includes: forming a third flexible film by using a dielectric elastomer material.

Optionally, forming the driving circuit layer on the side of the flexible deformation layer includes: forming a third driving electrode and a fourth driving electrode on a side of the third flexible film.

Optionally, forming the flexible deformation layer includes: forming a fourth flexible film by using a thermal expansion material.

Optionally, forming the driving circuit layer on the side of the flexible deformation layer includes: forming a fifth driving electrode on a side of the fourth flexible film.

In a third aspect, an embodiment of the present disclosure provides an electronic device, including the flexible actuator described above.

Optionally, the electronic device includes: a braille display or a flexible keyboard.

### BRIEF DESCRIPTION OF DRAWINGS

FIG. 1 is a schematic diagram showing a structure of a flexible actuator according to an embodiment of the present disclosure;

FIG. 2 is a sectional view showing the structure of the flexible actuator in FIG. 1 along a direction A-A′;

FIG. 3 is another schematic diagram showing a structure of a flexible actuator according to an embodiment of the present disclosure;

FIG. 4 is a sectional view showing the structure of the flexible actuator in FIG. 3 along a direction B-B′;

FIG. 5 is a schematic diagram showing another structure of a flexible actuator according to an embodiment of the present disclosure;

FIG. 6 is a sectional view showing the structure of the flexible actuator in FIG. 5 along a direction C-C′;

FIG. 7 is a flowchart showing a manufacturing method of a flexible actuator according to an embodiment of the present disclosure;

FIG. 8 is a schematic diagram showing structures corresponding to steps in a manufacturing method of a flexible actuator according to an embodiment of the present disclosure;

FIG. 9 is a schematic diagram showing structures corresponding to steps in a manufacturing method of another flexible actuator according to an embodiment of the present disclosure;

FIG. 10 is a schematic diagram showing structures corresponding to steps in a manufacturing method of still another flexible actuator according to an embodiment of the present disclosure;

FIG. 11 is a schematic diagram showing a structure of a braille display according to an embodiment of the present disclosure; and

FIG. 12 is a schematic diagram showing a structure of a flexible keyboard according to an embodiment of the present disclosure.

### DETAIL DESCRIPTION OF EMBODIMENTS

In order to enable those of ordinary skill in the art to better understand the technical solutions of the present disclosure, the present disclosure is further described in detail below with reference to the accompanying drawings and specific implementations.

Unless otherwise defined, technical terms or scientific terms used herein should have general meanings that are understood by those of ordinary skill in the technical field to which the present disclosure belongs. The words “first”, “second” and the like used herein do not denote any order, quantity or importance, but are just used to distinguish between different elements. Similarly, the words “one”, “a”, “the” and the like do not denote a limitation to quantity, and indicate the existence of “at least one” instead. The words “include”, “comprise” and the like indicate that an element or object before the words covers the elements or objects or the equivalents thereof listed after the words, rather than excluding other elements or objects. The words “connect”, “couple” and the like are not limited to physical or mechanical connection, but may also indicate electrical connection, whether direct or indirect. The words “on”, “under”, “left”, “right” and the like are only used to indicate relative positional relationships. When an absolute position of an object described is changed, the relative positional relationships may be changed accordingly.

The existing flexible actuators generally adopt a magnetic field control principle or a pneumatic control principle to realize drive control. For example, for a flexible actuator adopting the magnetic field control principle, a magnet or a conductive coil can be used to generate a magnetic field, and a relatively large volume of the magnet or the conductive coil is required in order to obtain a stronger magnetic field, which is not beneficial to miniaturization of the flexible actuator. In addition, for a flexible actuator adopting the pneumatic control principle, accurate control of the flexible actuator cannot be easily realized due to unstable pneumatic control, and the control program is complex. Thus, the existing flexible actuators fail to meet the requirements of users for miniaturization and programmable control of the flexible actuators.

In order to solve at least one of the above technical problems, embodiments of the present disclosure provide a flexible actuator, a manufacturing method thereof, and an electronic device. The flexible actuator, the manufacturing method thereof, and the electronic device in the embodiments of the present disclosure will be described in detail below in conjunction with the drawings and specific implementations.

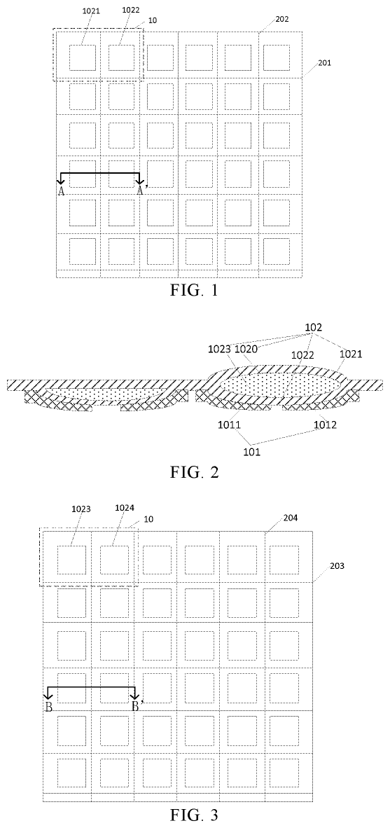

FIG. 1 is a schematic diagram showing a structure of a flexible actuator according to an embodiment of the present disclosure. As shown in FIG. 1, the flexible actuator includes: a plurality of flexible actuator units 10 arranged in an array. FIG. 2 is a sectional view showing the structure of the flexible actuator shown in FIG. 1 along a direction A-A′. As shown in FIG. 2, each of the flexible actuator units 10 includes: a driving circuit layer 101, and a flexible deformation layer 102 located on a side of the driving circuit layer 101; the driving circuit layer 101 is configured to provide a control signal for the flexible deformation layer 102; and the flexible deformation layer 102 is configured to deform under the control of the control signal.

In practical applications, a driving signal may be input to the driving circuit layer 101 from an external driver chip (not shown), and a control signal may be generated by the driving circuit layer 101 and be provided to the flexible deformation layer 102 of each of the flexible actuator units 10. The flexible deformation layer 102 may deform under the control of the control signal, for example, the flexible deformation layer 102 of each of one or more flexible actuator unit 10 of the plurality of the flexible actuator units 10 in the flexible actuator may protrude, so as to execute a certain instruction.

The flexible actuator provided by the embodiment of the present disclosure is composed of the plurality of flexible actuator units 10 arranged in an array, and each of the flexible actuator units 10 is only composed of the driving circuit layer 101 and the flexible deformation layer 102, so that the flexible actuator is simple in structure and small in size, and a deformation degree of the flexible deformation layer 102 is controllable, which is beneficial to the miniaturization of the flexible actuator; moreover, the flexible actuator is simple in manufacturing process, which is beneficial to mass production of the flexible actuator. On the other hand, all the flexible actuator units 10 of the flexible actuator are arranged in an array, and an electric signal can be independently input to each flexible actuator unit to realize independent control, so that programmable control of the flexible actuator can be carried out, thereby meeting the requirements of the users for the miniaturization and the programmable control of the flexible actuator.

In some embodiments, as shown in FIG. 2, the flexible deformation layer 102 includes: a first flexible film 1021 and a second flexible film 1022 disposed opposite to each other, and a closed cavity 1020 between the first flexible film 1021 and the second flexible film 1022; the driving circuit layer 101 includes: a first driving electrode 1011 and a second driving electrode 1012; and both the first driving electrode 1011 and the second driving electrode 1012 are located on a side of the second flexible film 1022 away from the first flexible film 1021.

The first flexible film 1021 and the second flexible film 1022 may be made of a same material such as polyimide (PI) or polydimethylsiloxane (PDMS). Or alternatively, the first flexible film 1021 and the second flexible film 1022 may be made of different materials. The materials of the first flexible film 1021 and the second flexible film 1022 may be appropriately selected as actual needed, and are not limited herein.

The first flexible films 1021 are attached to the second flexible films 1022 to form the closed cavity 1020. Edges of the second flexible film 1022 may be directly attached to the first flexible film 1021, and a section of the closed cavity 1020 such formed may have an oval shape as shown in FIG. 2. Or alternatively, the edges of the second flexible film 1022 may be attached to the first flexible film 1021 through an adhesive layer such as an optical adhesive layer, the adhesive layer may support the first flexible film 1021 and the second flexible film 1022, and a section of the closed cavity 1020 such formed may have a rectangle shape or other shapes (not shown). Preferably, the section of the closed cavity 1020 may have an oval shape as shown in FIG. 2.

each of the first driving electrode 1011 and the second driving electrode 1012 may be made of a metal material having good conductivity, and specifically the metal material may be any one of aluminum (Al), silver (Ag), titanium (Ti), and molybdenum (Mo), or an alloy of more of aluminum (Al), silver (Ag), titanium (Ti), and molybdenum (Mo). Apparently, the first driving electrode 1011 and the second driving electrode 1012 may also be made of one or more metal oxides such as Indium Tin Oxide (ITO) and Indium Zinc Oxide (IZO). Both the first driving electrode 1011 and the second driving electrode 1012 may be attached to a surface of the second flexible film 1022 away from the first flexible film 1021. When electric signals with different voltages are input to the first driving electrode 1011 and the second driving electrode 1012, an electrostatic force may be generated between the first driving electrode 1011 and the second driving electrode 1012 since the voltage of the electric signal input to the first driving electrode 1011 is different from the voltage of the electric signal input to the second driving electrode 1012, so that the first driving electrode 1011 and the second driving electrode 1012 are attracted by each other and deform to a certain extent. The larger the difference between the voltages is, the larger the deformation degree is.

The deformation generated by the first driving electrode 1011 and the deformation generated by the second driving electrode 1012 may be transmitted to the closed cavity 1020. Since each of the elastic modulus of the first flexible film 1021 and the elastic modulus of the second flexible film 1022 is much smaller than each of the elastic modulus of the first driving electrode 1011 and the elastic modulus of the second driving electrode 1012, the closed cavity 1020 may deform, i.e. bulge upward, along a direction departing/away from the first driving electrode 1011 and the second driving electrode 1012. The closed cavity 1020 of each of one or more flexible actuator units 10 of the plurality of the flexible actuator units 10 in the flexible actuator may be controlled by a program to bulge, so as to execute a specific instruction, thereby realizing the programmable control of the flexible actuator.

In some embodiments, as shown in FIG. 2, a first preset gap is provided between the first driving electrode 1011 and the second driving electrode 1012, and both the first driving electrode 1011 and the second driving electrode 1012 are bent along a direction away from the first flexible film 1021.

A width of the first preset gap provided between the first driving electrode 1011 and the second driving electrode 1012 may be specifically set according to sizes of the first driving electrode 1011 and the second driving electrode 1012. When no electric signals are input to the first driving electrode 1011 and the second driving electrode 1012, a distance between the first driving electrode 1011 and the second driving electrode 1012 is equal to the width of the first preset gap. When the electric signals with the different voltages are input to the first driving electrode 1011 and the second driving electrode 1012, the electrostatic force may be generated between the first driving electrode 1011 and the second driving electrode 1012 since the voltage of the electric signal input to the first driving electrode 1011 is different from the voltage of the electric signal input to the second driving electrode 1012, so that the first driving electrode 1011 and the second driving electrode 1012 are attracted by each other. Both the first driving electrode 1011 and the second driving electrode 1012 are bent toward the first flexible film 1021 from the initial states thereof. Under the action of the electrostatic force, the first driving electrode 1011 and the second driving electrode 1012 are pulled closer to each other to deform towards the first flexible film 1021. The deformation may be transmitted to the closed cavity 1020, so that the closed cavity 1020 may deform, i.e. bulge upward, along the direction departing from the first driving electrode 1011 and the second driving electrode 1012. The closed cavity 1020 of each of one or more flexible actuator unit 10 of the plurality of the flexible actuator units 10 in the flexible actuator may be controlled by a program to bulge, so as to execute a specific instruction, thereby realizing the programmable control of the flexible actuator.

In some embodiments, as shown in FIG. 2, a bending radian of the first driving electrode 1011 is the same as a bending radian of the second driving electrode 1012.

With the bending radian of the first driving electrode 1011 being the same as the bending radian of the second driving electrode 1012, it can be ensured that the first driving electrode 1011 and the second driving electrode 1012 are closely attached to the surface/side of the second flexible film 1022 away from the first flexible film 1021 at the same radian. Moreover, it can be ensured that an end of the first driving electrode 1011 and an end of the second driving electrode 1012 opposite to each other are located at a same horizontal position, so that the first driving electrode 1011 and the second driving electrode 1012 have such large facing areas that the electrostatic force between the first driving electrode 1011 and the second driving electrode 1012 is large enough to obviate the need to input electric signals with larger voltages to the first driving electrode 1011 and the second driving electrode 1012, thereby saving power consumption.

In some embodiments, as shown in FIG. 2, the flexible deformation layer 102 further includes: a filler 1023 disposed in the closed cavity 1020.

When the closed cavity 1020 deforms, the air in the closed cavity is prone to be compressed, which may affect a deformation amount of the whole closed cavity 1020. The closed cavity 1020 may be filled with the filler 1023, and the filler 1023 may adopt a gas or a liquid with stable performance, such as one or more of water, silicone oil and helium. Preferably, the closed cavity 1020 may be filled with the silicone oil. On the one hand, the silicone oil has stable performance and is not prone to conduct electricity, so that the silicone oil may not damage the devices in the driving circuit layer 101. On the other hand, the silicone oil has a relatively high density and cannot be easily compressed, so that an influence of compressed silicone oil on the deformation amount of the whole closed cavity 1020 can be avoided when the closed cavity 1020 deforms, thereby improving control accuracy of the flexible actuator. It should be understood that the filler 1023 may employ other liquids or gases with good flexibility, which will not be listed here one by one, and implementation principles of those liquids and gases are the same as the above implementation principle and thus will not be repeated here.

In some embodiments, as shown in FIG. 1, the flexible actuator further includes: a plurality of first control signal lines 201 and a plurality of second control signal lines 202 arranged in an intersecting manner; the first driving electrodes 1011 and the second driving electrodes 1012 in a same row of flexible actuator units 10 are connected to a same first control signal line 201; and the first driving electrodes 1011 in a same column of flexible actuator units 10 are connected to a same second control signal line 202, and the second driving electrodes 1012 in a same column of flexible actuator units 10 are connected to a same second control signal line 202.

The plurality of first control signal lines 201 may be arranged along a row direction, the plurality of second control signal lines 202 may be arranged along a column direction. Each first control signal line 201 may be connected to the first driving electrode 1011 and the second driving electrode 1012. After a signal is input into the first control signal line 201, the first driving electrode 1011 and the second driving electrode 1012 may be connected to corresponding second control signal lines 202, so that electric signals having different voltages are input to the first driving electrode 1011 and the second driving electrode 1012 through the corresponding second control signal lines 202, thus generating an electrostatic force between the first driving electrode 1011 and the second driving electrode 1012 and the first driving electrode 1011 is attracted to each other. Both the first driving electrode 1011 and the second driving electrode 1012 are bent bent along the direction departing from the first flexible film 1021 from the initial state. Under the action of the electrostatic force, the first driving electrode 1011 and the second driving electrode 1012 are pulled closer to each other to deform towards the first flexible film 1021. The deformation may be transmitted to the closed cavity 1020, so that the closed cavity 1020 may deform, i.e. bulge upward, along the direction departing from the first driving electrode 1011 and the second driving electrode 1012. The closed cavity 1020 of each of one or more flexible actuator units 10 of the plurality of flexible actuator units 10 in the flexible actuator may be controlled by a program to bulge, so as to execute a specific instruction, thereby realizing the programmable control of the flexible actuator.

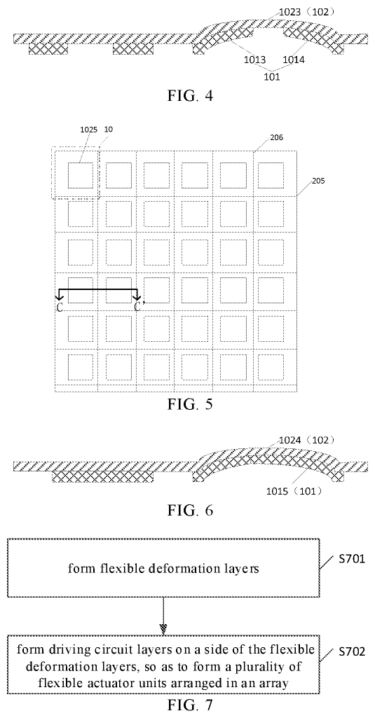

FIG. 3 is a schematic diagram showing another structure of a flexible actuator according to an embodiment of the present disclosure, and FIG. 4 is a sectional view showing the structure of the flexible actuator in FIG. 3 along a direction B-B′. As shown in FIG. 3 and FIG. 4, the flexible deformation layer 102 of each flexible actuator unit 10 in the flexible actuator includes: a third flexible film 1023, and a material of the third flexible film 1023 includes: a dielectric elastomer material. The driving circuit layer 101 includes: a third driving electrode 1013 and a fourth driving electrode 1014 on a side of the third flexible film 1023.

The third driving electrode 1013 and the fourth driving electrode 1014 may be made of a metal material having good conductivity, and specifically the metal material may be any one of aluminum (Al), silver (Ag), titanium (Ti), and molybdenum (Mo), or an alloy of more of aluminum (Al), silver (Ag), titanium (Ti), and molybdenum (Mo). Apparently, the third driving electrode 1013 and the fourth driving electrode 1014 may also be made of one or more metal oxides such as Indium Tin Oxide (ITO) and Indium Zinc Oxide (IZO). Both the third driving electrode 1013 and the fourth driving electrode 1014 may be attached to a surface of the third flexible film 1023. When electric signals with different voltages are input to the third driving electrode 1013 and the fourth driving electrode 1014, an electric field may be generated between the third driving electrode 1013 and the fourth driving electrode 1014. Since the third flexible film 1023 is made of the dielectric elastomer material, the third flexible film 1023 may deform under the action of the electric field; moreover, since the elastic modulus of the third flexible film 1023 is much smaller than the elastic moduli of the third driving electrode 1013 and the fourth driving electrode 1014, the third flexible film 1023 may deform, i.e. protrude upward, along a direction departing from the third driving electrode 1013 and the fourth driving electrode 1014. The third flexible film 1023 of each of one or more of the plurality of the flexible actuator units 10 in the flexible actuator may be controlled by a program to protrude, so as to execute a specific instruction, thereby realizing the programmable control of the flexible actuator.

In some embodiments, as shown in FIG. 4, a second preset gap is provided between the third driving electrode 1013 and the fourth driving electrode 1014, and both the third driving electrode 1013 and the fourth driving electrode 1014 are bent toward the third flexible film 1023.

A width of the second preset gap provided between the third driving electrode 1013 and the fourth driving electrode 1014 may be specifically set according to sizes of the third driving electrode 1013 and the fourth driving electrode 1014. It should be noted that the width of the second preset gap may be greater than that of the first preset gap. Since in the flexible actuator shown in FIG. 4, it is only required to generate the electric field between the third driving electrode 1013 and the fourth driving electrode 1014, a small gap between the third driving electrode 1013 and the fourth driving electrode 1014 do not need to be formed. When the electric signals with the different voltages are input to the first driving electrode 1011 and the second driving electrode 1012, the electric field may be generated between the third driving electrode 1013 and the fourth driving electrode 1014. Since the third flexible film 1023 is made of the dielectric elastomer material, the third flexible film 1023 may deform under the action of the electric field; moreover, since the elastic modulus of the third flexible film 1023 is much smaller than the elastic moduli of the third driving electrode 1013 and the fourth driving electrode 1014, the third flexible film 1023 may deform, i.e. bulge upward, along the direction departing from the third driving electrode 1013 and the fourth driving electrode 1014. The third flexible film 1023 of each of one or more of the plurality of the flexible actuator units 10 in the flexible actuator may be controlled by a program to bulge, so as to execute a specific instruction, thereby realizing the programmable control of the flexible actuator.

The flexible actuator shown in FIG. 3 and FIG. 4 differs from the flexible actuator shown in FIG. 1 and FIG. 2 in that the flexible deformation layer 102 of each flexible actuator unit 10 in the flexible actuator shown in FIG. 3 and FIG. 4 includes only the third flexible film 1023 made of the dielectric elastomer material. the third flexible film 1023 of each of one or more of the plurality of the flexible actuator units 10 in the flexible actuator can deform in a case of only one flexible film, so that the structure of the flexible actuator can be simplified, which facilitates thinning of the flexible actuator, thereby further improving a degree of the miniaturization of the flexible actuator.

In some embodiments, a bending radian of the third driving electrode 1013 is the same as a bending radian of the fourth driving electrode 1014.

With the bending radian of the third driving electrode 1013 being the same as the bending radian of the fourth driving electrode 1014, it can be ensured that the third driving electrode 1013 and the fourth driving electrode 1014 are closely attached to the surface of the third flexible film 1023 at the same radian. Moreover, it can be ensured that an end of the third driving electrode 1013 and an end of the fourth driving electrode 1014 opposite to each other are located at a same horizontal position, so that a stable electric field may be generated between the third driving electrode 1013 and the fourth driving electrode 1014, thereby improving the control accuracy of the flexible actuator.

In some embodiments, as shown in FIG. 3, the flexible actuator further includes: a plurality of third control signal lines 203 and a plurality of fourth control signal lines 204 arranged in an intersecting manner; the third driving electrodes 1013 and the fourth driving electrodes 1014 in a same row of flexible actuator units 10 are connected to a same third control signal line 203; and the third driving electrodes 1013 in a same column of flexible actuator units 10 are connected to a same third control signal line 203, and the fourth driving electrodes 1014 in a same column of flexible actuator units 10 are connected to a same fourth control signal line 204.

The plurality of third control signal lines 203 may be arranged along a row direction, the plurality of fourth control signal lines 204 may be arranged along a column direction. The third control signal line 203 may be connected to the third driving electrode 1013 and the fourth driving electrode 1014 respectively. After a signal is input to the third control signal line 203, the third driving electrode 1013 and the fourth driving electrode 1014 may be connected to corresponding fourth control signal lines 204, so that electric signals having different voltages are transmitted to the third driving electrode 1013 and the fourth driving electrode 1014 through the corresponding fourth control signal lines 204, thus generating the stable electric field between the third driving electrodes 1013 and the fourth driving electrodes 1014. Thus, the third flexible films 1023 made of the dielectric elastomer material may deform, i.e. bulge upward, along the direction departing from the third driving electrode 1013 and the fourth driving electrode 1014. The third flexible film 1023 of each of one or more of the plurality of the flexible actuator units 10 in the flexible actuator may be controlled by a program to bulge, so as to execute a specific instruction, thereby realizing the programmable control of the flexible actuator.

FIG. 5 is a schematic diagram showing another structure of a flexible actuator according to an embodiment of the present disclosure, and FIG. 6 is a sectional view showing the structure of the flexible actuator in FIG. 5 along a direction C-C′. As shown in FIG. 5 and FIG. 6, the flexible deformation layer 102 of each of the flexible actuator units 10 in the flexible actuator includes: a fourth flexible film 1024, and a material of the fourth flexible film 1024 includes a thermal expansion material; the driving circuit layer 101 includes: a fifth driving electrode 1015 on a side of the fourth flexible film 1024.

The fifth driving electrode 1015 may be made of a metal material which is capable of easily converting electrical energy into thermal energy after being powered, and specifically the metal material may be any one of chromium (Cr), manganese (Mn), and tungsten (W), or an alloy of more of chromium (Cr), manganese (Mn), and tungsten (W). The fifth driving electrode 1015 may be attached to a surface of the fourth flexible film 1024. When an electric signal is input to the fifth driving electrode 1015, the fifth driving electrode 1015 may generate heat. Since the fourth flexible film 1024 is made of the thermal expansion material, the fourth flexible film 1024 may deform under the action of the heat; moreover, since an elastic modulus of the fourth flexible film 1024 is much smaller than an elastic modulus of the fifth driving electrode 1015, the fourth flexible film 1024 may deform, i.e. bulge upward, along a direction departing from the fifth driving electrode 1015. The fourth flexible film 1024 of each of one or more of the plurality of the flexible actuator units 10 in the flexible actuator may be controlled by a program to bulge, so as to execute a specific instruction, thereby realizing the programmable control of the flexible actuator.

In some embodiments, the fifth driving electrode 1015 has a resistance value greater than a preset value.

The fifth driving electrode 1015 may have a relatively large resistance value, for example, greater than 100 ohms or more, so as to convert the electrical energy into the thermal energy more effectively, so that a relatively large amount of heat is applied to the fourth flexible film 1024 to ensure that the fourth flexible film 1024 deforms significantly. It should be understood that the resistance of the fifth driving electrode 1015 may be set according to actual needs and is not limited herein.

In some embodiments, as shown in FIG. 6, the fifth driving electrode 1015 is bent toward the fourth flexible film 1024.

When the electric signal is input to the fifth driving electrode 1015, the fifth driving electrode 1015 converts the electrical energy into the thermal energy. Since the fourth flexible film 1024 is made of the thermal expansion material, the fourth flexible film 1024 may deform under the action of the heat; moreover, since the elastic modulus of the fourth flexible film 1024 is much smaller than the elastic modulus of the fifth driving electrode 1015, the fourth flexible film 1024 may deform, i.e. bulge upward, along the direction departing from the fifth driving electrode 1015. The fourth flexible film 1024 of each of one or more of the plurality of the flexible actuator units 10 in the flexible actuator may be controlled by a program to bulge, so as to execute a specific instruction, thereby realizing the programmable control of the flexible actuator.

The flexible actuator shown in FIG. 5 and FIG. 6 differs from the flexible actuator shown in FIG. 3 and FIG. 4 in that the flexible deformation layer 102 of each of the flexible actuator units 10 in the flexible actuator shown in FIG. 5 and FIG. 6 includes only one film layer, i.e., the fourth flexible film 1024 made of the thermal expansion material, and the driving circuit layer 101 only includes the fifth driving electrode 1015. Only one flexible film and one driving electrode can control the third flexible film 1023 of each of one or more of the plurality of the flexible actuator units 10 in the flexible actuator to deform, so that the structure of the flexible actuator can be further simplified, which facilitates the thinning of the flexible actuator, thereby further improving the miniaturization degree of the flexible actuator.

In some embodiments, the flexible actuator further includes: a plurality of fifth control signal lines 205 and a plurality of sixth control signal lines 206 arranged in an intersecting manner; the fifth driving electrodes 1015 in a same row of flexible actuator units 10 are connected to a same fifth control signal line 205; and the fifth driving electrodes 1015 in a same column of flexible actuator units 10 are connected to a same sixth control signal line 206.

The plurality of fifth control signal lines 205 may be arranged along a row direction, the plurality of sixth control signal lines 206 may be arranged along a column direction. Each of the fifth control signal lines 205 may be connected to the fifth driving electrodes 1015 in a same row of flexible actuator units 10. After a signal is input to the fifth control signal line 205, the fifth driving electrodes 1015 may be connected to corresponding sixth control signal lines 206, so that electric signals transmitted by the corresponding sixth control signal lines 206 may be input to the fifth driving electrodes 1015 respectively to enable the fifth driving electrodes 1015 to generate heat. Thus, the fourth flexible film 1024 made of the thermal expansion material may deform, i.e. bulge upward, along the direction departing from the fifth driving electrodes 1015. The fourth flexible film 1024 of each of one or more of the plurality of the flexible actuator units 10 in the flexible actuator may be controlled by a program to bulge, so as to execute a specific instruction, thereby realizing the programmable control of the flexible actuator.

An embodiment of the present disclosure further provide a manufacturing method of a flexible actuator, and FIG. 7 is a flowchart showing the manufacturing method of the flexible actuator in the embodiment of the present disclosure. As shown in FIG. 7, the manufacturing method of the flexible actuator includes: step S701, forming a flexible deformation layer; and step S702, forming driving circuit layers on a side of the flexible deformation layer, so as to form a plurality of flexible actuator units arranged in an array.

Each of the steps in the manufacturing method of the flexible actuator in the embodiment of the present disclosure will be described in detail below with reference to specific flexible actuators.

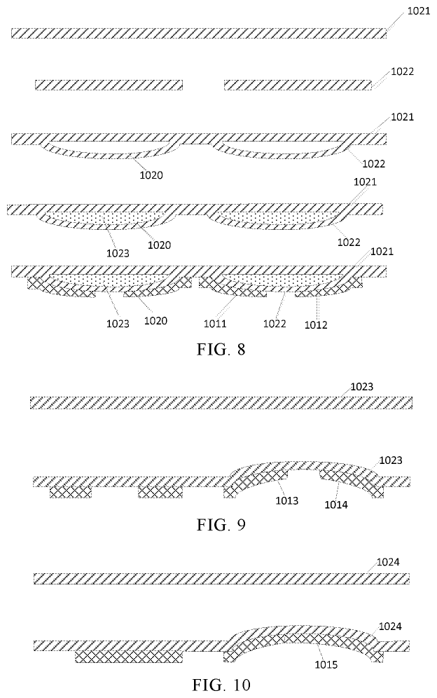

FIG. 8 is a schematic diagram showing structures corresponding to steps in a manufacturing method of a flexible actuator according to an embodiment of the present disclosure. At step S701, as shown in FIG. 8, a first flexible film 1021 is formed at first. A second flexible film 1022 is cut into a plurality of second flexible films 1022 in suitable sizes. Then, edges of each of the plurality of second flexible films 1022 are attached to the first flexible film 1021 through a high temperature process and the like, so as to form a plurality of closed cavities 1020. The closed cavities 1020 may be filled with a filler material 1023 and sealed, so as to fully fill an internal space of each of the closed cavities 1020 with the filler material 23. At step S702, a first driving electrode 1011 and a second driving electrode 1012 are formed on a side/surface of each of the second flexible films 1022 away from the first flexible film 1021. It should be understood that first control signal lines and second control signal lines, which are connected to the first driving electrodes 1011 and the second driving electrodes 1012, may be formed in synchronization with the formation of the first driving electrode 1011 and the second driving electrode 1012.

In some embodiments, FIG. 9 is a schematic diagram showing structures corresponding to steps in a manufacturing method of another flexible actuator according to an embodiment of the present disclosure. At step S701, as shown in FIG. 9, a third flexible film 1023 is first formed from a dielectric elastomer material. At step S702, as shown in FIG. 9, third driving electrodes 1013 and fourth driving electrodes 1014 are formed on a side of the third flexible film 1023. It should be understood that third control signal lines and fourth control signal lines, which are connected to the third driving electrodes 1013 and the fourth driving electrodes 1014, may be formed in synchronization with the formation of the third driving electrodes 1013 and the fourth driving electrodes 1014.

In some embodiments, FIG. 10 is a schematic diagram showing structures corresponding to steps in a manufacturing method of still another flexible actuator according to an embodiment of the present disclosure. At step S701, as shown in FIG. 10, a fourth flexible film 1024 is first formed from a thermal expansion material. At step S702, as shown in FIG. 10, the fifth driving electrodes 1015 are formed on a side of the fourth flexible film 1024. It should be understood that fifth control signal lines and sixth control signal lines, which are connected to the fifth driving electrodes 1015, may be formed at the same time when the fifth driving electrodes 1015 are formed.

An embodiment of the present disclosure further provides an electronic device, which includes the flexible actuator in any one of the above embodiments. Specifically, the electronic device may be a braille display or a flexible keyboard.

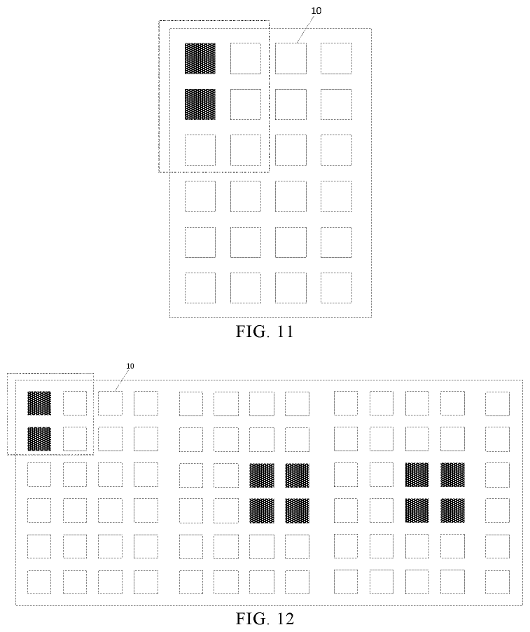

FIG. 11 is a schematic diagram showing a structure of a braille display according to an embodiment of the present disclosure. As shown in FIG. 11, in a flexible actuator of the braille display, every six adjacent flexible actuator units 10 are marked as a group, and driving electrodes in the flexible actuator units 10 are powered under the control of a program, so that different flexible actuator units 10 deform to bulge under the action of an electrostatic force, an electric field or thermal energy (filling with a dark color indicates a bulging state and not filling with the dark color indicates a non-bulging state), thereby displaying a single braille character or a plurality of braille characters. As shown in FIG. 11, the braille character “b” is displayed.

FIG. 12 is a schematic diagram showing a structure of a flexible keyboard according to an embodiment of the present disclosure. As shown in FIG. 12, in a flexible actuator of the flexible keyboard, every fourth adjacent flexible actuator units 10 are marked as a group with a size of the group being the same as a size of one key of a standard keyboard. Driving electrodes in the flexible actuator units 10 are powered under the control of a program as actual needed to customize bulging states or flat states of the keys (filling with the dark color indicates a bulging state and not filling with the dark color indicates a non-bulging state). Thus, man-machine interaction can be effectively improved, and the keys can be prevented from being mistakenly touched, thereby improving user experience.

It should be understood that the above implementations are merely exemplary implementations adopted to illustrate the principle of the present disclosure, and the present disclosure is not limited thereto. Various modifications and improvements can be made by those of ordinary sill in the art without departing from the spirit and essence of the present disclosure, and those modifications and improvements should be considered to fall within the scope of the present disclosure.

1. A flexible actuator, comprising: a plurality of flexible actuator units arranged in an array; wherein
each of the plurality of flexible actuator units comprises: a driving circuit layer, and a flexible deformation layer located on a side of the driving circuit layer,
the driving circuit layer is configured to provide a control signal for the flexible deformation layer, and
the flexible deformation layer is configured to deform under the control of the control signal.

2. The flexible actuator of claim 1, wherein
the flexible deformation layer comprises: a first flexible film and a second flexible film opposite to each other, and a closed cavity is formed between the first flexible film and the second flexible film, and
the driving circuit layer comprises: a first driving electrode and a second driving electrode; and each of the first driving electrode and the second driving electrode is on a side of the second flexible film away from the first flexible film.

3. The flexible actuator of claim 2, wherein a first preset gap is between the first driving electrode and the second driving electrode, and both the first driving electrode and the second driving electrode are bent away from the first flexible film, and
a bending radian of the first driving electrode is the same as a bending radian of the second driving electrode.

4. (canceled)

5. The flexible actuator of claim 2, wherein the flexible deformation layer further comprises: a filler material in the closed cavity, and
the filler material comprises: one or more of water, silicone oil and helium.

6. (canceled)

7. The flexible actuator of claim 2, further comprising: a plurality of first control signal lines and a plurality of second control signal lines arranged in an intersecting manner; wherein
first driving electrodes and second driving electrodes in a same row of flexible actuator units are connected to a same first control signal line, and
first driving electrodes in a same column of flexible actuator units are connected to a same second control signal line, and second driving electrodes in a same column of flexible actuator units are connected to a same second control signal line.

8. The flexible actuator of claim 1, wherein the flexible deformation layer comprises: a third flexible film; and a material of the third flexible film comprises: a dielectric elastomer material; and
the driving circuit layer comprises: a third driving electrode and a fourth driving electrode; and each of the third driving electrode and the fourth driving electrode is on a side of the third flexible film.

9. The flexible actuator of claim 8, wherein a second preset gap is between the third driving electrode and the fourth driving electrode, and both the third driving electrode and the fourth driving electrode are bent toward the third flexible film, and
a bending radian of the third driving electrode is the same as a bending radian of the fourth driving electrode.

10. (canceled)

11. The flexible actuator of claim 8, further comprising: a plurality of third control signal lines and a plurality of fourth control signal lines arranged in an intersecting manner; wherein
third driving electrodes and fourth driving electrodes in a same row of flexible actuator units are connected to a same third control signal line, and
third driving electrodes in a same column of flexible actuator units are connected to a same third control signal line, and fourth driving electrodes in a same column of flexible actuator units are connected to a same fourth control signal line.

12. The flexible actuator of claim 1, wherein the flexible deformation layer comprises: a fourth flexible film; and a material of the fourth flexible film comprises: a thermal expansion material; and
the driving circuit layer comprises: a fifth driving electrode on a side of the fourth flexible film.

13. The flexible actuator of claim 12, wherein resistance of the fifth driving electrode is greater than a preset value, and
the fifth driving electrode is bent toward the fourth flexible film.

14. (canceled)

15. The flexible actuator of claim 12, further comprising: a plurality of fifth control signal lines and a plurality of sixth control signal lines arranged in an intersecting manner; wherein
fifth driving electrodes in a same row of flexible actuator units are connected to a same fifth control signal line, and
fifth driving electrodes in a same column of flexible actuator units are connected to a same sixth control signal line.

16. A method for manufacturing a flexible actuator, comprising:
forming a flexible deformation layer; and
forming a driving circuit layer on a side of the flexible deformation layer, so as to form a plurality of flexible actuator units arranged in an array.

17. The method of claim 16, wherein forming the flexible deformation layer comprises:
forming a first flexible film; and
attaching a second flexible film to the first flexible film to form a cavity.

18. The method of claim 17, after attaching the second flexible film to the first flexible film to form the plurality of closed cavities, further comprising:
injecting a filler material into the cavity and sealing the cavity.

19. The method of claim 17, wherein forming the driving circuit layer on the side of the flexible deformation layer comprises:
forming a first driving electrode and a second driving electrode on a side of the second flexible film away from the first flexible film.

20. The method of claim 16, wherein forming the flexible deformation layer comprises:
forming a third flexible film by using a dielectric elastomer material.

21. The method of claim 20, wherein forming the driving circuit layer on the side of the flexible deformation layer comprises:
forming a third driving electrode and a fourth driving electrode on a side of the third flexible film.

22. The method of claim 16, wherein forming the flexible deformation layer comprises:
forming a fourth flexible film by using a thermal expansion material.

23. The method of claim 22, wherein forming the driving circuit layer on the side of the flexible deformation layer comprises:
forming a fifth driving electrode on a side of the fourth flexible film.

24. An electronic device, comprising:
the flexible actuator of claim 1; and
a braille display or a flexible keyboard.

25. (canceled)
